(19) United States
(12) Patent Application Publication
(10) Pub. No.: US 2018/0204419 A1
(43) Pub. Date: Jul. 19, 2018

(54) METHOD, SYSTEM AND GAMING MACHINE FOR PLAYING A CARD GAME

(71) Applicants: Mark Olaf Peterson, West Jordan, UT (US); Shane G. Peterson, Ferron, UT (US)

(72) Inventors: Mark Olaf Peterson, West Jordan, UT (US); Shane G. Peterson, Ferron, UT (US)

(21) Appl. No.: 15/682,328

(22) Filed: Aug. 21, 2017

Related U.S. Application Data
(60) Provisional application No. 62/447,978, filed on Jan. 19, 2017.
(60) Provisional application No. 62/458,106, filed on Feb. 13, 2017.

(51) Int. Cl. G07F 17/32; A63F 3/00

(52) U.S. Cl. CPC G07F 17/3293; A63F 3/00157

(57) ABSTRACT

Disclosed is a method of playing a card game. The method includes receiving one or more bets from each of multiple players, displaying multiple hand cards from a card deck, receiving one or more hand card selections from each of the multiple players and displaying multiple flop cards selected from the card deck. Further, the method includes receiving one or more of a second bet, a call, and a fold from each of the multiple players in response to selection of the multiple flop cards. Further, the method includes displaying one or more turn cards selected from the card deck and displaying one or more river cards selected from the card deck. Moreover, the method includes forming multiple hands corresponding to the multiple players. Further, the method includes identifying a winning hand from the multiple hands and rewarding the player associated with the winning hand.

The current application claims priority to the U.S. Provisional Patent Application Ser. No. 62/447,978 filed on Jan. 19, 2017 and the U.S. Provisional Patent Application Ser. No. 62/458,106 filed on Feb. 13, 2017.

### FIELD OF THE INVENTION

The present invention relates to gaming. In particular, the present invention relates to a method, a system, and a game machine for playing a card game.

### BACKGROUND OF THE INVENTION

Gambling, casinos, and table games are extremely popular in society. The Internet and mobile electronic devices are also expanding the reach of these games. However, the players may not want to play the traditional games all the time. Often, the players have played the traditional games for years, which may make them less interesting to the players.

Thus, it would be advantageous to develop a new card game to increase the variability of casino table games and keep the players interested in the card games.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of playing a card game. The method includes receiving one or more bets from each of multiple players. Further, the method includes displaying multiple hand cards from a card deck, wherein a count of the multiple hand cards is at least equal to a count of the multiple players. Yet further, the method includes receiving one or more hand card selections from each of the multiple players, wherein the one or more hand card selections select one or more hand cards from the multiple hand cards. Moreover, the method includes displaying multiple flop cards selected from the card deck. Further, the method includes receiving one or more of a second bet, a call, and a fold from each of the multiple players in response to selection of the multiple flop cards, wherein the call received from a player matches an initial bet from the at least one bet previously received from the player, and wherein the fold received from a player forfeits at least a portion of the bet received from the player. Further, the method includes displaying one or more turn cards selected from the card deck. Yet further, the method includes displaying one or more river cards selected from the card deck. Moreover, the method includes forming multiple hands corresponding to the multiple players, wherein a hand corresponding to a player comprises the one or more hand cards associated with the player and one or more community cards selected from multiple community cards comprising the multiple flop cards, the one or more turn cards and the one or more river cards, wherein each of the multiple hands is associated with a hand rank, wherein a hand rank associated with a hand is based on one or more of multiple card ranks associated with multiple cards comprised in the hand and a count of the multiple cards associated with a card rank. Further, the method includes identifying a winning hand from the multiple hands, wherein a hand rank associated with the winning hand is greater than a hand rank associated with every other hand of the multiple hands. Further, the method includes rewarding the player associated with the winning hand.

According to some aspects, a gaming machine is disclosed. The gaming machine includes an input device configured for receiving one or more bets from each of multiple players and receiving one or more hand card selections from each of the multiple players, wherein the one or more hand card selections select one or more hand cards from the multiple hand cards. Further, the input device is configured for receiving at least one of a second bet, a call, and a fold from each of the multiple players in response to selection of the multiple flop cards, wherein the call received from a player matches an initial bet from the at least one bet previously received from the player, and wherein the fold received from a player forfeits at least a portion of the bet received from the player. Yet further, the input device is configured for forming multiple hands corresponding to the multiple players, wherein a hand corresponding to a player comprises the one or more hand cards associated with the player and one or more community cards selected from multiple community cards comprising multiple flop cards, one or more turn cards, and one or more river cards, wherein each of the multiple hands is associated with a hand rank, wherein a hand rank associated with a hand is based on one or more of multiple card ranks associated with multiple cards comprised in the hand and a count of the multiple cards associated with a card rank. Further, the gaming machine includes an output device configured for displaying multiple hand cards from a card deck, wherein a count of the multiple hand cards is at least equal to a count of the multiple players. Further, the output device is configured for displaying the multiple flop cards selected from the card deck, displaying the one or more turn cards selected from the card deck and displaying the one or more river cards selected from the card deck. Yet further, the gaming machine includes a processing device configured for identifying a winning hand from the multiple hands, wherein a hand rank associated with the winning hand is greater than a hand rank associated with every other hand of the multiple hands. The processing device is also configured for rewarding the player associated with the winning hand.

According to some aspects, a card game is disclosed. First, the players place an initial bet and they have the option to place a bonus bet. Then, the dealer deals ten hands face up in the middle of the table. Each player then chooses from these hands starting with the player on a button and moving to the left until everyone has a hand. Then the dealer mucks the remaining cards. Then, the dealer burns a card and puts out the flop cards. At this time, the players that want to continue playing their hand must match the initial bet. The players that fold lose their initial bet, but still have the chance to win the bonus bet, if they get three of a kind or better. The turn card and river card are dealt and the winning players are paid.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 illustrates a flowchart of a method of playing a card game, in accordance with some embodiments.

FIG. 3A is a schematic illustrating a state of a card game in accordance with an exemplary embodiment.

FIG. 3B is a schematic illustrating a state of the card game in accordance with the exemplary embodiment.

FIG. 4A is a schematic illustrating a state of the card game in accordance with the exemplary embodiment.

FIG. 4B is a schematic illustrating a state of the card game in accordance with the exemplary embodiment.

FIG. 5A is a schematic illustrating a state of the card game in accordance with the exemplary embodiment.

FIG. 5B is a schematic illustrating a state of the card game in accordance with the exemplary embodiment.

FIG. 5C is a schematic illustrating a state of the card game in accordance with the exemplary embodiment.

FIG. 6A illustrates a hand in the card game in accordance with the exemplary embodiment.

FIG. 6B illustrates a hand in the card game in accordance with the exemplary embodiment.

FIG. 7 is a block diagram of a gaming machine for playing a card game in accordance with some embodiments.

FIG. 8 illustrates an exemplary computing system that may be employed to implement processing functionality for various embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header. The present disclosure includes many aspects and features. Moreover, while many aspects and features relate to, and are described in, the context of provisioning a card game, embodiments of the present disclosure are not limited to use only in this context.

Overview

The present disclosure relates to card game with two sets of rules, one for a single table format and another for a tournament format. The single table format includes the following rules. One to seven players play on a single casino table. Players can join or leave at any time. Each round a button moves once clockwise. Before receiving cards, each player is required to place an initial bet between a minimum amount and a maximum amount; the initial bet pays even money. The player has the option to play a bonus bet. In one embodiment, the bonus bet pays 75% return to the player. In another embodiment, the bonus bet pays as follows: Three of a kind-3:2, Straight-2:1, Flush-3:1, Full House-5:1, Four of the kind-8:1, Straight Flush-20:1, and Royal Flush-100:1. After bets are placed the dealer deals out 10 hands face up. The player on the button goes first and chooses the hand he or she wants. Then the player immediately to the left picks from the remaining hands and this continues until everyone has a hand. The dealer places each chosen hand in front of the player. Then the dealer mucks the remaining hands not chosen. Once everyone has a hand the dealer burns one card and turns three cards face up for the flop. After the flop, each player has the option to call or fold, starting with the player on the button; if they call they have to match their initial bet. If they fold they lose their initial bet but they can still win the bonus bet. Then the dealer proceeds to burn a card and deal the turn card. Immediately after the turn card is dealt the dealer burns a card and deals the river card. To win the initial bet and call bet the player must get at least three of a kind. Winners get paid even money on their initial bet and call bet at this time. Then the bonus bet is paid or lost. The bonus bet is lost if the player didn't make at least three of a kind or better.

The tournament format includes the following rules. The tournament format uses a multiple table elimination tournament style with a buy-in and a pay out of the top 10% of the field. Eight players play per table. The casino decides the buy-in and pay-out. Dealers deal one card to each player, player with the highest card gets the button. Each round the button moves clockwise once. To begin the game, the dealer deals out 10 hands face up. The player on the button takes the hand he or she wants. Then the player immediately to the left picks the hand they want and so on around the table until everyone has a hand. Then the dealer mucks the remaining hands not chosen. Once everyone has a hand the dealer burns one card and turns three cards face up for the flop. After the flop, the dealer sets out 10 more hands face up. Unlike the first choosing of cards, the player immediately to the left of the button chooses first. Then the next player to the left chooses and so on until everyone has two separate hands. After everyone has two hands the dealer mucks the remaining hands not chosen. Dealer burns a card and turns the turn card, and then burns another card and turns the river card. After the river card, the dealer gives the player with the winning Texas Hold'em hand a casino chip. Players have a chance to win using their two separate hands. In the case of a tie the dealer deals a card to each player and the high card wins the chip. When one player on a table wins a certain amount of chips determined by the casino, the player moves to the next round (this tournament style is called a shootout). Tournament payouts are decided by the casino.

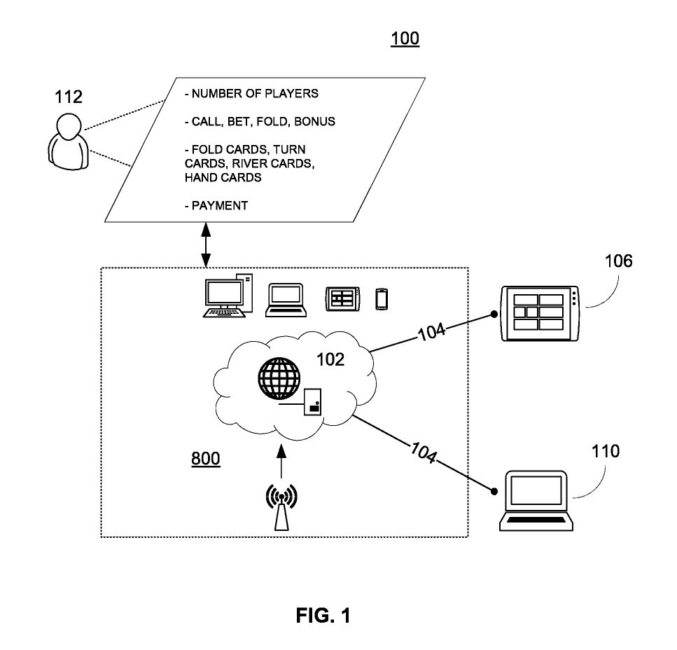

Referring now to figures, FIG. 1 is an illustration of a platform consistent with various embodiments of the present disclosure. By way of non-limiting example, the online platform 100 for provisioning a card game may be hosted on a centralized server 102, such as, for example, a cloud computing service. The centralized server 102 may communicate with other network entities, such as, for example, a mobile device (such as a smartphone, a laptop, a tablet computer etc.) and other electronic devices (such as desktop computers, etc.) over a communication network 104, such as, but not limited to, the Internet. Further, users of the platform may include one or more relevant parties such as, players and administrators. Accordingly, electronic devices operated by the one or more relevant parties may be in communication with the platform. For example, the platform may be in communication with a player electronic device 106 operated by the player and an administrator electronic device 110 operated by the administrator.

A user 112, such as the one or more relevant parties, may access platform 100 through a software application. The software application may be embodied as, for example, but not be limited to, a website, a web application, a desktop application, a mobile application and a gaming machine compatible with a computing device 800. Accordingly, in an instance, the user 112 may be a player who may place a bet in a round of a card game.

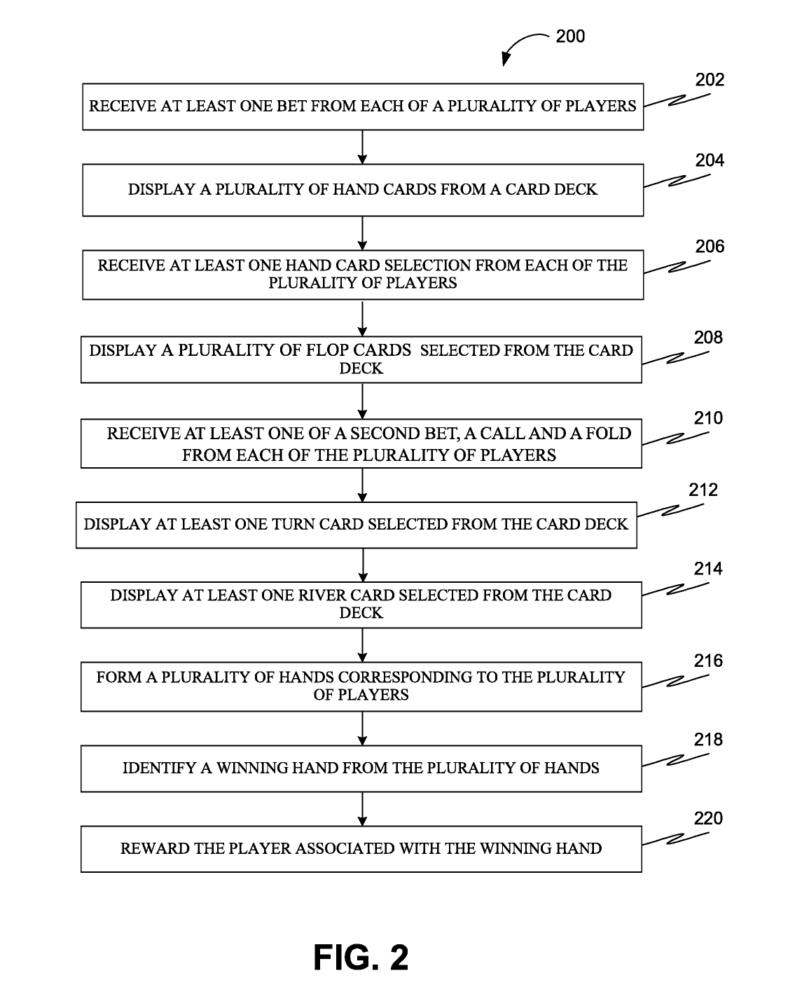

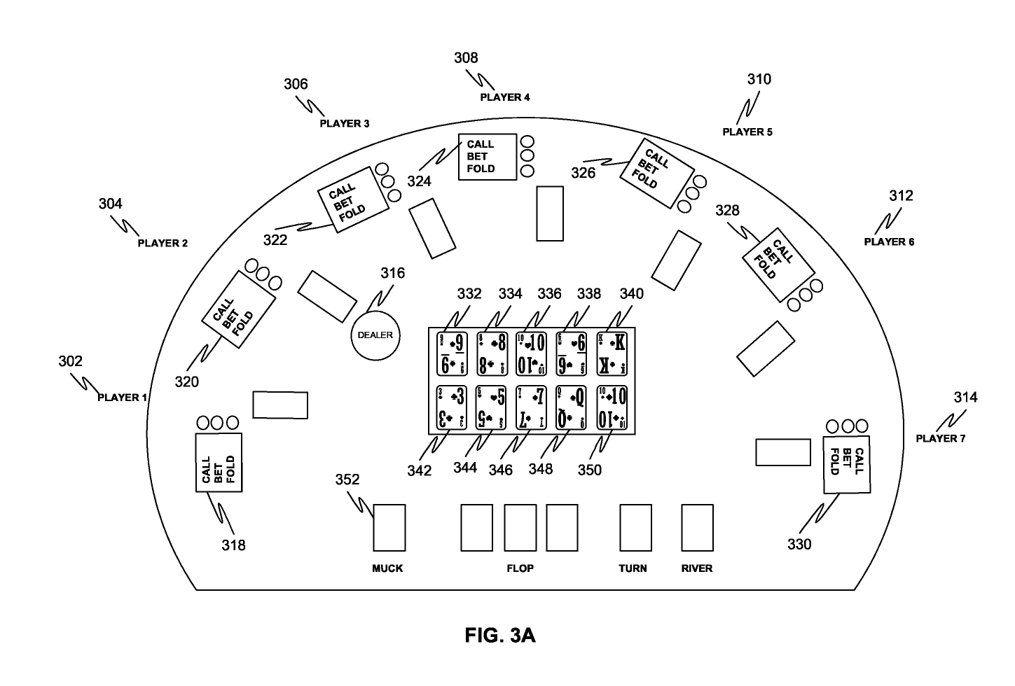

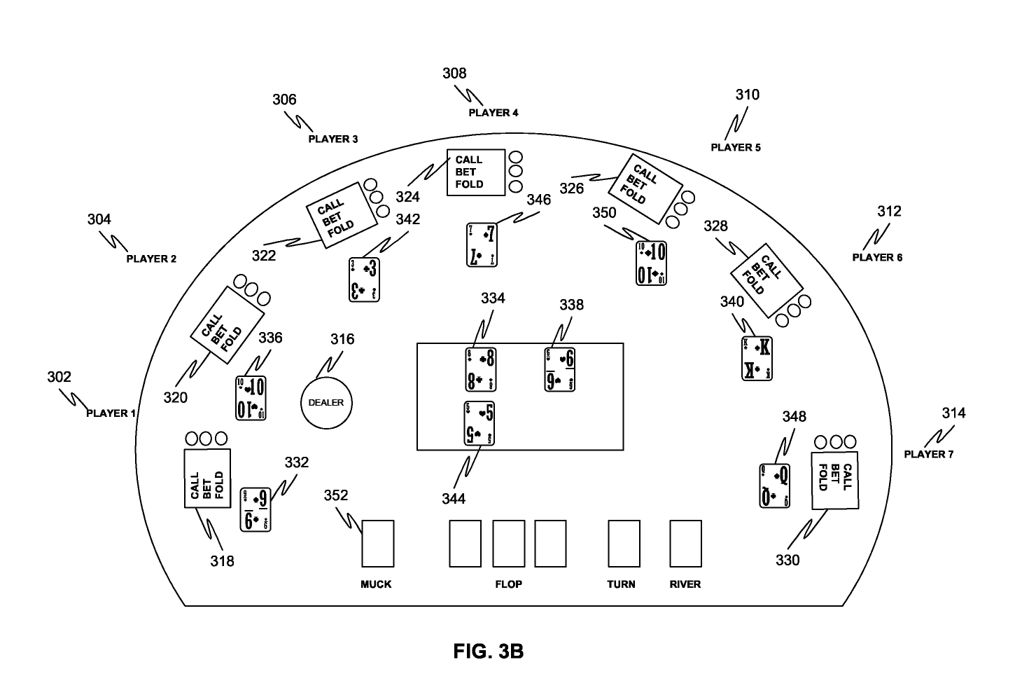

FIG. 2 illustrates a flowchart of a method 200 of playing a card game, in accordance with some embodiments. At 202, the method 200 includes receiving one or more bets from each of multiple players, for a round of the card game. A bet received from a player contributes a bet amount to a pot associated with a round of the card game. The players may be positioned around a playing area as shown in FIG. 3A. The game may include seven players 302-314. Therefore, each of the seven players may place a bet. Each bet may include an initial bet and a bonus bet. For each round of the card game, a dealer is identified by a dealer button 316. After each round, the dealer button 116 moves once clockwise.

FIGS. 3A-B, 4A-B, 5A-C show various stages of a round of the card game according to some exemplary embodiments. FIGS. 3A-B, 4A-B, 5A-C may relate to user interfaces on an electronic device (such as a gaming machine). The user interfaces show a basic layout of the card game. The multiple players 302-314 have access to user interface input elements 318-330 respectively. The user interface input elements 318-336 allow each player to perform one or more of a second bet, a call, and a fold. For example, the user interface input elements 318-330 one or more text elements, radio buttons, check boxes, and submit buttons.

At 204, the method 200 includes displaying multiple hand cards from a card deck. The multiple hand cards may be displayed by the dealer. A count of the multiple hand cards is at least equal to a count of the multiple players. In some embodiments, the count of the multiple hand cards is greater than the count of the multiple players. For example, the count of the multiple hand cards may be equal to ten. Accordingly, as shown in FIG. 3A, ten hand cards 332-350 may be laid open. The players do not have any hand cards at this stage. The ten hand cards 332-350 may include a nine of spades 332, an eight of clubs 334, a ten of hearts 336, a six of hearts 338, a king of spades 340, a three of clubs 342, a five of hearts 344, a seven of spades 346, a queen of spades 348 and a ten of diamonds 350.

At 206, the method 200 includes receiving one or more hand card selections from each of the multiple players. The one or more hand card selections select one or more hand cards from the multiple hand cards. The dealer may place one or more hand cards in front of respective players based on the one or more hand card selections.

According to some embodiments, the one or more hand card selections are received from each of the multiple players in a sequence, wherein a beginning of the sequence corresponds to each of the multiple players in multiple rounds of the card game respectively. Therefore, the receiving one or more hand card selections may include the player on the dealer button first choosing the one or more hand cards she wants. Then the player immediately to the left may pick from the remaining hands and this may continue until each player has one or more hand cards. Further, in some embodiments, the one or more hand cards comprises two hand cards.

Yet further, the one or more hand card selections may include a first hand card selection and a second hand card selection, wherein the first hand card selection selects one or more first hand cards from a first plurality of hand cards, wherein the second hand card selection selects one or more second hand cards from a second plurality of hand cards. Further, each of the first hand card selection and the second hand card selection may be received from each of the multiple players in a first sequence and a second sequence respectively, wherein a beginning of the first sequence associated with the first hand selection corresponds to a first player of the multiple players, wherein a beginning of the second sequence associated with the second hand selection is associated with a second player adjacent to the first player. In an embodiment, the first hand card selection and the second hand card selection are performed prior to displaying flop cards. In another embodiment, the first hand card selection is performed prior to displaying the flop cards, wherein the second hand card selection is performed subsequent to displaying the flop cards.

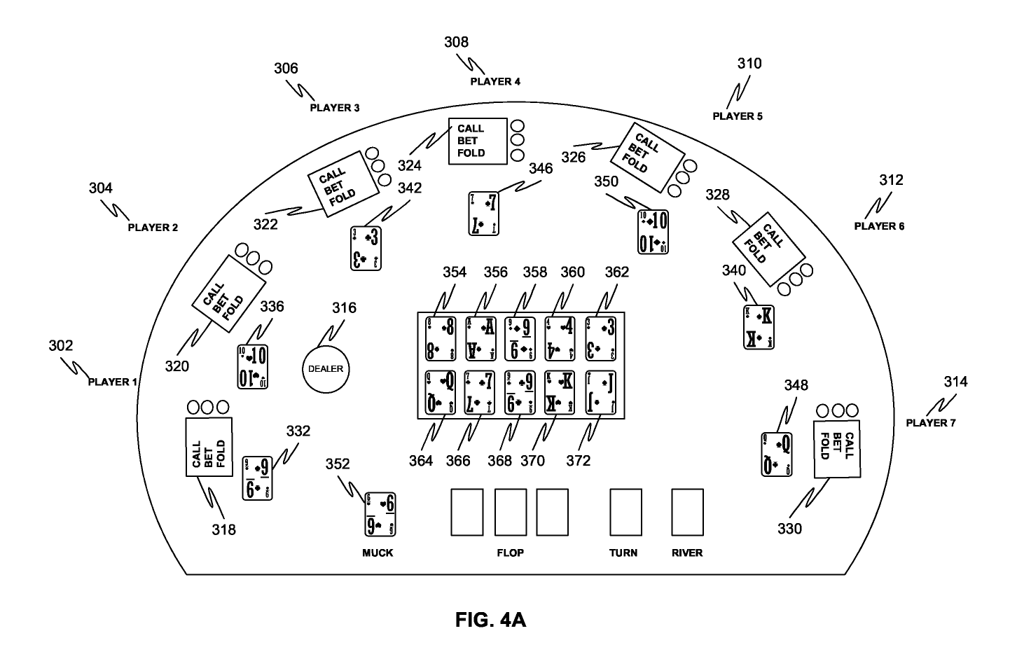

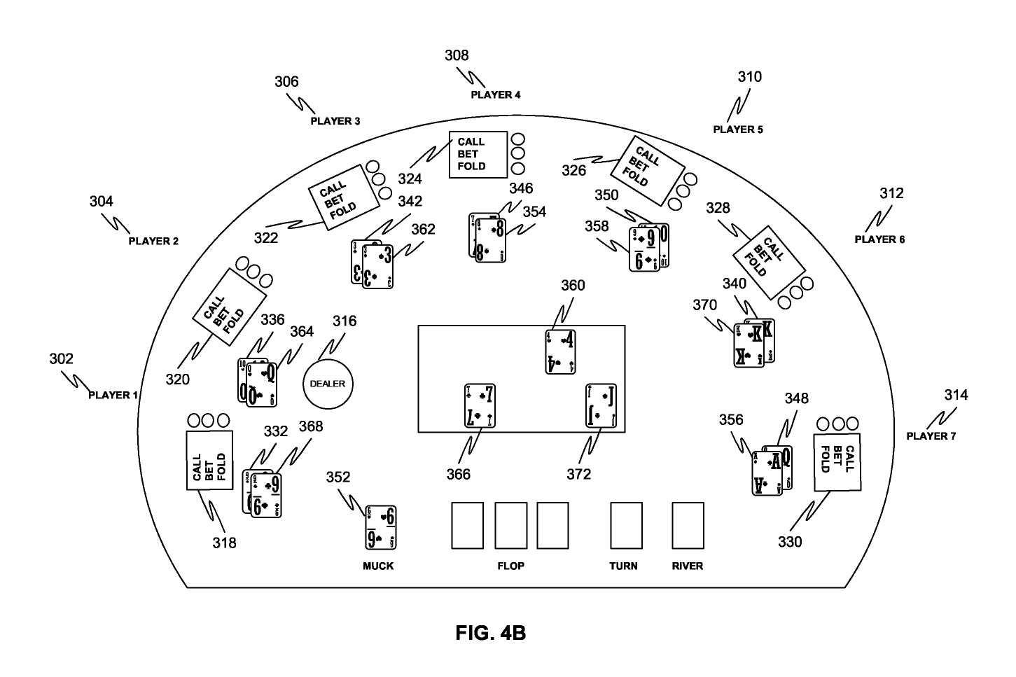

Accordingly, as shown in FIG. 3B, hand card selections are received from each of the multiple players 302-314, such that each player selects a one hand card each from the ten hand cards 332-350. This may correspond to a first hand card selection. The player 302 may select a nine of spades 332, the player 304 may select the ten of hearts 336, the player 306 may select the three of clubs 342, the player 308 may select the seven of spades 346, the player 310 may select the ten of diamonds 350, the player 312 may select the king of spades 340, and the player 314 may select the queen of spades 348. Thereafter, as shown in FIG. 4A, the three remaining cards including the eight of clubs 334, the six of hearts 338, and the five of hearts 344 are moved to a muck position 352. The dealer may move the three remaining cards to the muck position 352.

Accordingly, as shown in FIG. 4A, ten hand cards 354-372 may be laid open. The ten hand cards 354-372 include an eight of spades 354, an ace of spades 356, a nine of diamonds 358, a four of hearts 360, a three of spades 362, a queen of hearts 364, a seven of clubs 366, a nine of clubs 368, a king of hearts 370 and a jack of spades 372. Again, hand card selections are received from each of the multiple players 302-314, such that each player selects a one hand card each from the ten hand cards 354-372. This may correspond to a second hand card selection. As shown in FIG. 4B, the player 302 may select the nine of clubs 368, the player 304 may select the queen of hearts 364, the player 306 may select the three of spades 362, the player 308 may select the eight of spades 354, the player 310 may select the nine of diamonds 358, the player 312 may select the king of hearts 370, and the player 314 may select the ace of spades 356. At this stage, each player in the multiple players 302-314 has two hand cards. Although, the hand cards are shown face up in the FIGS. 3A-B, 4A-B, 5A-C, but they are visible to the respective players only.

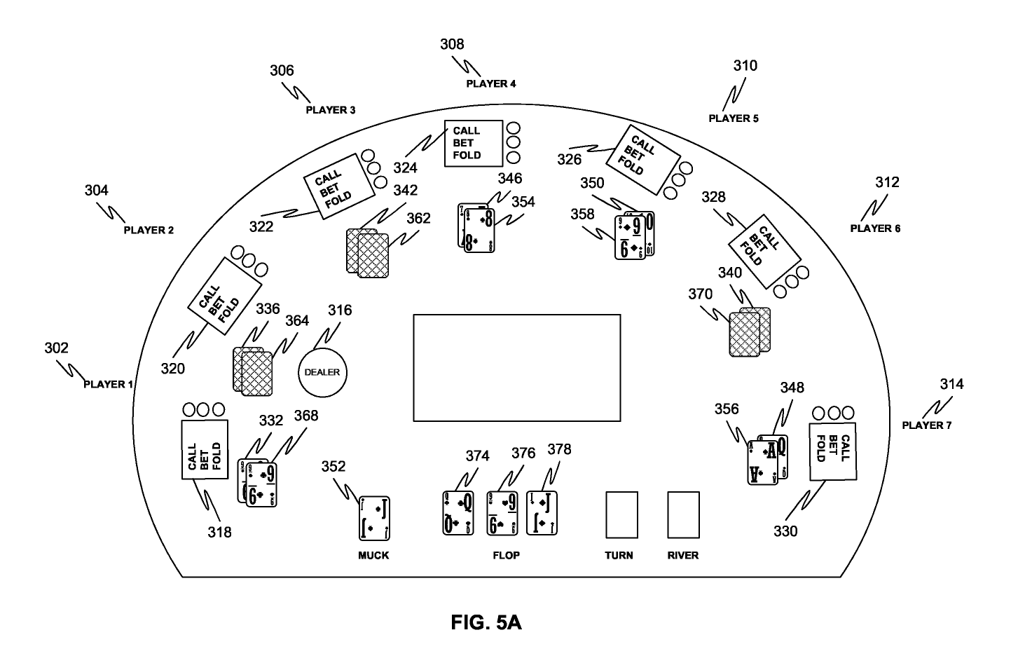

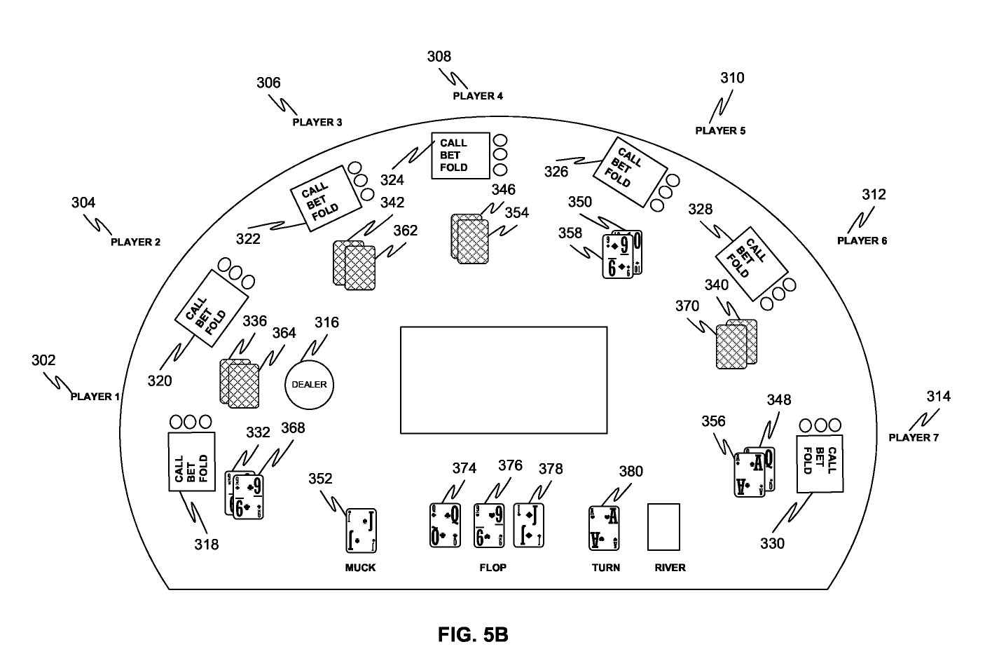

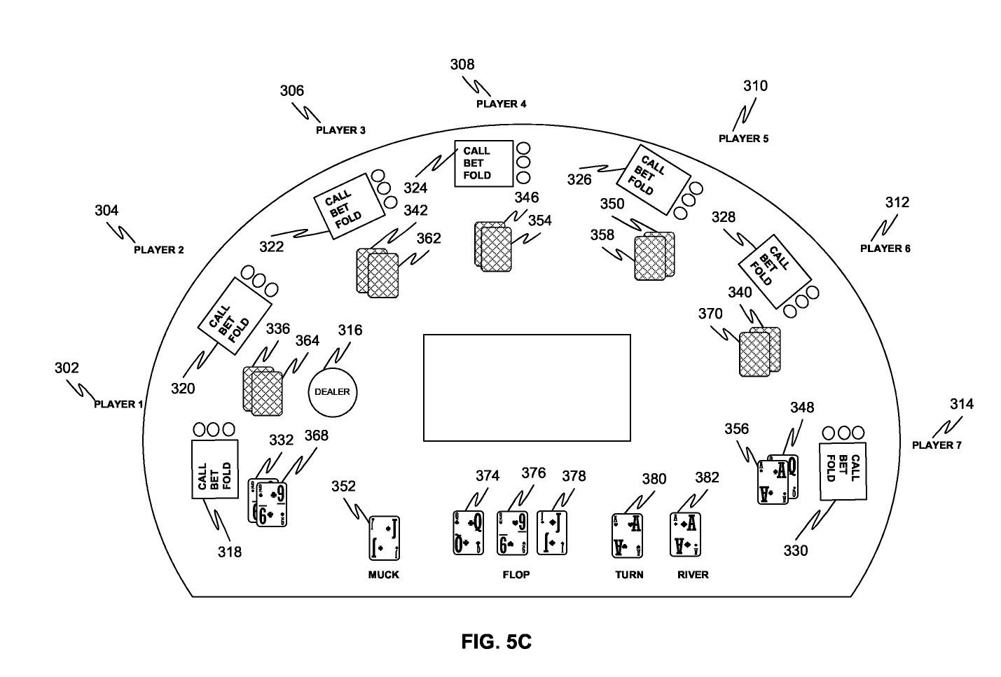

Thereafter, as shown in FIG. 5A, the three remaining cards including the four of hearts 360, the seven of clubs 366, and the jack of spades 372 are moved to the muck position 352. The dealer may move the three remaining cards to the muck position 352.

At 208, the method 200 includes displaying multiple flop cards selected from the card deck. The dealer may display the multiple flop cards. In some embodiments, one or more cards may be burned prior to displaying the multiple flop cards. For example, the one or more cards may be burned by placing the one or more cards in the muck position 352. Accordingly, as shown in FIG. 5A, three flop cards 374-378 may be displayed. The three flop cards 374-378 may include a queen of clubs 374, a nine of hearts 376 and a jack of diamonds 378.

At 210, the method 200 includes receiving one or more of a second bet, a call, and a fold from each of the multiple players. The call received from a player includes matching the initial bet amount previously received from the player. The fold received from a player forfeits at least a portion of the bet received from the player, namely the initial bet. Accordingly, as shown in FIG. 5A, each of the multiple players 302-314 may use the respective user interface input element from the user interface input elements 318-330 to select one or more of a bet, a call, and a fold. For example, the players 304, 306, and 312 may fold (as shown by their overturned hard cards). Further, the players 302, 308, 310 and 314 may continue placing bets.

At 212, the method 200 includes displaying one or more turn cards selected from the card deck. The dealer may display the one or more turn cards. In some embodiments, one or more cards may be burned prior to displaying the one or more turn cards. Accordingly, as shown in FIG. 5B, a turn card 380 is displayed. The turn card 380 may be an ace of hearts.

At 214, the method 200 includes displaying one or more river cards selected from the card deck. The dealer may display the one or more river cards. In some embodiments, one or more cards may be burned prior to displaying the one or more river cards. Accordingly, as shown in FIG. 5C, a river card 382 is displayed. The turn card 380 may be an ace of diamonds.

At 216, the method 200 includes forming multiple hands corresponding to the multiple players, wherein a hand corresponding to a player comprises the one or more hand cards associated with the player and one or more community cards selected from multiple community cards comprising the multiple flop cards, the one or more turn cards, and the one or more river cards. Each of the multiple hands may be associated with a hand rank, wherein a hand rank associated with a hand is based on at least one of multiple card ranks associated with multiple cards comprised in the hand and a count of the multiple cards associated with a card rank.

The hand ranks may be determined based on predefined rules. For example, the lowest hand rank is called high card, and it is a hand with no pairs. The next lowest hand rank is called one pair, and it is a hand with one pair, that is a hand with two identical cards (such as two nines). The next lowest hand rank is called two pairs, and it is a hand with two pairs, that is a hand with two sets of two identical cards (such as two nines and two queens). The next lowest hand rank is called three of a kind, and it is a hand with three identical cards (such as three jacks). The next lowest hand rank is called a straight, and it is a hand with all cards in a sequence (such as, a ten, a nine, an eight, a seven and a six). The next lowest hand rank is called a flush, and it is a hand with all cards with same suit (such as all spades). The next lowest hand rank is called a full house, and it is a hand with three of a kind and a pair (such as three kings and two aces). The next lowest hand rank is called a four of a kind, and it is a hand with four identical cards (such as four aces and one king). The next lowest hand rank is called a straight flush, and it is a hand with all cards in a sequence and all cards with same suit (such as, a ten of spades, a nine of spades, an eight of spades, a seven of spades and a six of spades). The next hand rank is called a royal flush, and it is a hand with the highest straight flush (such as, an ace of spades, a king of spades, a queen of spades, a jack of spades and a ten of spades).

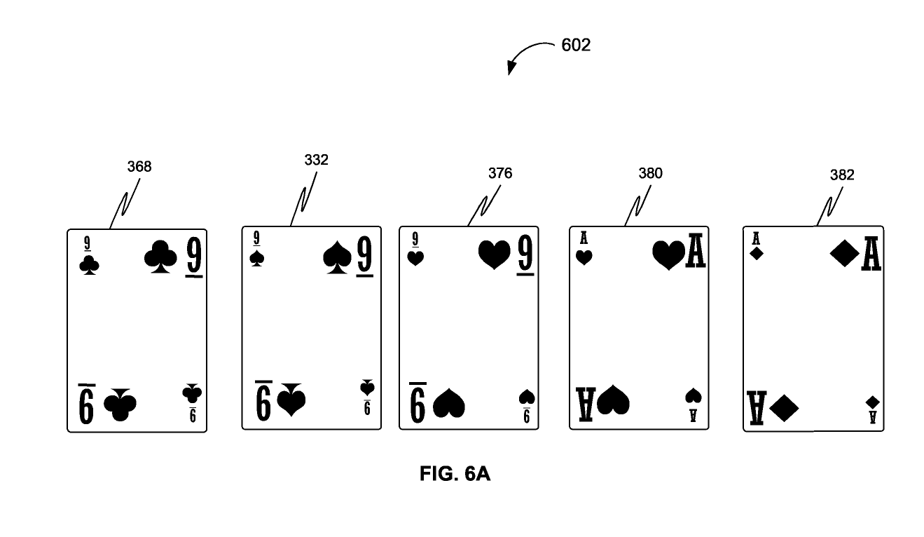

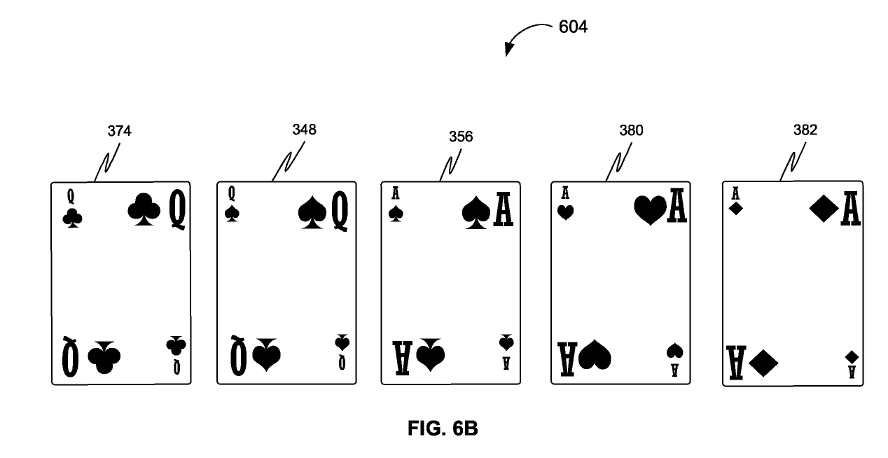

As shown in FIG. 5C, the players 302 and 314 are the only players still in the game. FIG. 6A shows a hand 602 formed by the player 302 using the hand cards 332, 368 and the community cards 376, 380 382. FIG. 6B shows a hand 604 formed by the player 314 using the hand cards 348, 356 and the community cards 374, 380 382.

At 218, the method 200 includes identifying a winning hand from the multiple hands. In some embodiments, a hand rank associated with the winning hand is greater than or equal to a predetermined hand rank. In some embodiments, the predetermined hand rank is three of a kind. More than one of the multiple hands may be considered the winning hand. Accordingly, as shown in FIG. 6A, the hand 602 includes a full house, with three of a kind (three nines) and a pair (two aces). Further, as shown in FIG. 6B, the hand 604 also includes a full house, with three of a kind (three aces) and a pair (two queens). The hand rank of both the hand 604 and the hand 602 is greater than the predetermined hand rank; therefore, both the hand 604 and the hand 602 are identified as the winning hand.

At 220, the method 200 includes rewarding the player associated with the winning hand. The reward may be equal to the initial bet and the call, a percentage of the bonus bet, the second bet, or a combination thereof. Accordingly, the player 314 and the player 302 may be rewarded at least the initial bet and the call, as the hand 604 and the hand 602 are the winning hands.

In some embodiments, a hand rank associated with the winning hand is greater than a hand rank associated with every other hand of the multiple hands. In some embodiments, the winning hand may include at least two pairs of cards, wherein each card of a pair of cards is associated with an identical card rank, wherein a card rank associated with at least one of the two pairs is at least equal to ten. In other embodiments, the winning hand may have the hand rank being greater than or equal to three of a kind.

Accordingly, as shown in FIG. 6A, the hand 602 includes a full house, with three of a kind (three nines) and a pair (two aces). Further, as shown in FIG. 6B, the hand 604 also includes a full house, with three of a kind (three aces) and a pair (two queens). The count of the hand 604 is higher than the count of the hand 602; therefore, the hand 604 is identified as the winning hand. The reward may include multiple bets received from the multiple players during the round of the card game. Accordingly, the player 314 may be rewarded as the hand 604 is the winning hand.

According to some embodiments, at 202, the method 200 may include receiving a bonus bet from one or more players. The one or more players may select from various available options to play the bonus bet. In one embodiment, the bonus bet pays 75% return to the player. In another embodiment, the bonus bet pays as follows: Three of a kind 3:2, Straight 2:1, Flush 3:1, Full House 5:1, Four of the kind 8:1, Straight Flush 20:1, and Royal Flush 100:1. Accordingly, the method 200 may also include identifying a bonus winning hand from the multiple hands, wherein the bonus winning hand is characterized by at least three of a kind and rewarding the bonus bet to the player associated with the bonus winning hand. Accordingly, the player 314 may also be rewarded the bonus bet (5:1), if the player 314 placed a bonus bet at 202. Similarly, the player 302 may be rewarded the bonus bet (5:1), if the player 302 placed a bonus bet at 202. Further, the players who fold during the round of the card game may also be eligible to win the bonus bet. The bonus bet is lost if the respective player does not make at least three of a kind or better.

In some embodiments, FIGS. 3A-B, 4A-B, 5A-C may relate to a table card game (such as a casino table game).

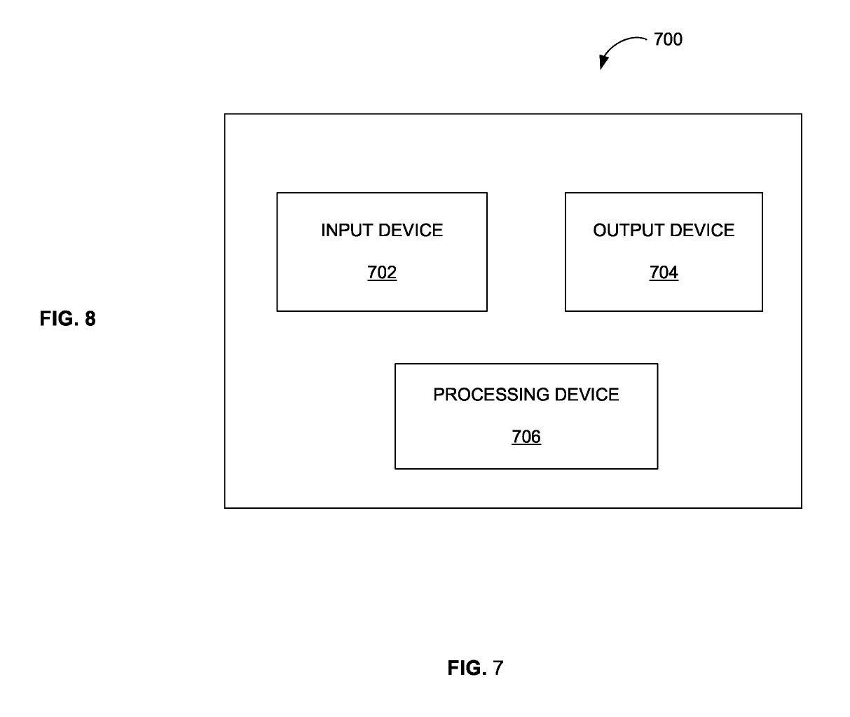

FIG. 7 is a block diagram of a gaming machine 700 for playing a card game in accordance with some embodiments. The gaming machine may include an input device 702, an output device 704 and a processing device 706.

The input device 702 may be configured for receiving one or more bets from each of multiple players. Further, the input device 702 may be configured for receiving one or more hand card selections from each of the multiple players. Further, the one or more hand card selections selects one or more hand cards from the multiple hand cards. Further, the input device 702 may be configured for receiving one or more of a second bet, a call, and a fold from each of the multiple players in response to selection of the multiple flop cards. For example, the input device 702 may include the user interface input elements (such as the user interface input elements 318-330), which may be used by the players to provide one or more of a second bet, a call, and a fold. Further, the call received from a player matches the initial bet amount previously received from the player. Further, the fold received from a player forfeits the player from winning at least a percentage of the bet amount previously received from the player, namely the initial bet. Further, the input device 702 may be configured for forming multiple hands corresponding to the multiple players. Further, a hand corresponding to a player may include the one or more hand cards associated with the player and one or more community cards selected from multiple community cards including multiple flop cards, one or more turn cards and one or more river cards. Further, each of the multiple hands may be associated with a hand rank. Further, a hand rank associated with a hand may be based on one or more of multiple card ranks associated with multiple cards comprised in the hand and a count of the multiple cards associated with a card rank.

Further, the output device 704 may be configured for displaying multiple hand cards from a card deck. Further, a count of the multiple hand cards may be at least equal to a count of the multiple players. Further, the output device 704 may be configured for displaying the multiple flop cards selected from the card deck. Further, the output device 704 may be configured for displaying the one or more turn cards selected from the card deck. Further, the output device 704 may be configured for displaying the one or more river cards selected from the card deck. The output device 704 may include a display.

Moreover, the processing device 706 may be configured for identifying a winning hand from the multiple hands. Further, a hand rank associated with the winning hand may be greater than a hand rank associated with every other hand of the multiple hands. Further, the processing device 706 may be configured for rewarding the player associated with the winning hand.

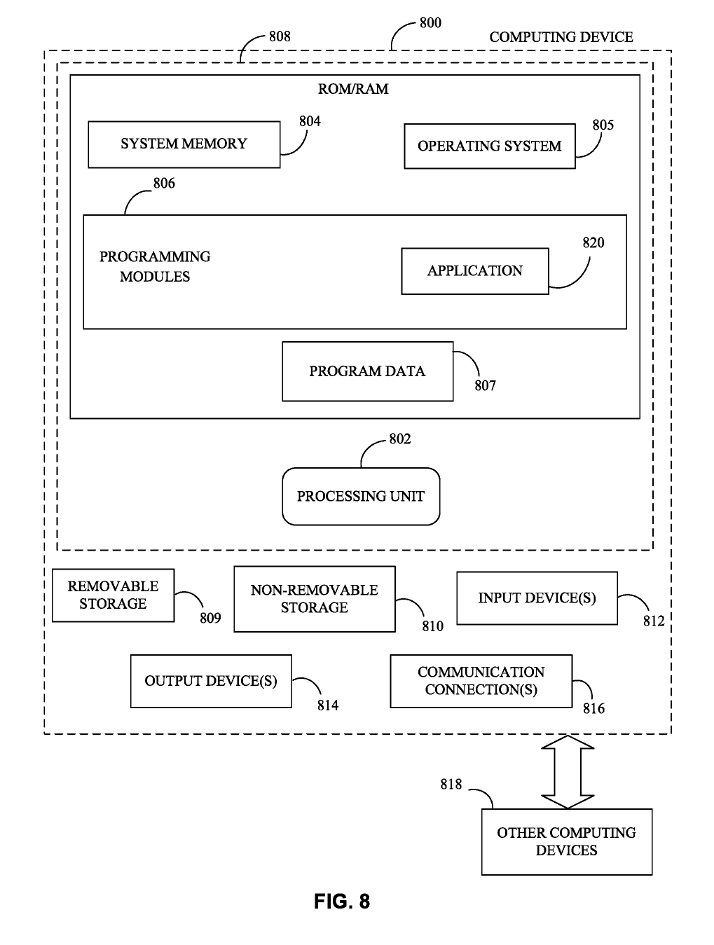

FIG. 8 is a block diagram of a system including computing device 800. Consistent with an embodiment of the disclosure, the aforementioned memory storage and processing unit may be implemented in a computing device, such as computing device 800 of FIG. 8. Any suitable combination of hardware, software, or firmware may be used to implement the memory storage and processing unit. For example, the memory storage and processing unit may be implemented with computing device 800 or any of other computing devices 818, in combination with computing device 800. The aforementioned system, device, and processors are examples and other systems, devices, and processors may comprise the aforementioned memory storage and processing unit, consistent with embodiments of the disclosure.

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820) may perform processes including, for example, one or more stages of method 200 as described above. The aforementioned process is an example, and processing unit 802 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

According to some embodiments, a casino table game is disclosed. There can be two to eight players on a single table; or in the case of a multiple table tournament, eight players per table. The casino may decide the buy in and pay outs. The dealer deals one card to each player, and the player with the highest card gets the button. Each round, the button moves clockwise once. To begin the game, the dealer deals out 10 hands face up. The player on the button takes the hand she wants. Then, the player immediately to the left picks the hand they want and so on around the table until everyone has a hand. Then, the dealer mucks the remaining hands not chosen. Once everyone has a hand, the dealer burns one card and turns three cards face up for the flop. After the flop, the dealer sets out 10 more hands face up. Unlike the first choosing of cards, the player immediately to the left of the button chooses first. Then, the next player to the left chooses and so on until everyone has two separate hands. After everyone has two hands, the dealer mucks the remaining hands not chosen. Then, the dealer proceeds to burn a card and deal the turn card; immediately after the turn, the dealer burns another card and deals the river card. After the river card, the dealer gives the player with the winning Texas Hold'em hand a casino chip. Players have two chances to win and cannot combine their two hands. In the case of a tie, the dealer deals a card to each player, and the high card wins the chip. When one player wins three chips by winning three rounds, they win the pot on a single table. Players in a tournament will move on to the next table, getting closer to the pot won at the end of the tournament. Further, optional for the casino is a bonus bet. The bonus bets are placed by the player before each round for the chance to hit the bonus pot. There are four bonus pots, the first and lowest is making a Full House, the second is a Four-of-a-Kind, the third is a Straight Flush, and the highest pot is making a Royal Flush. Players may choose one hand from the hands in the middle of the table before the flop and again after the flop. Further, players may place a bet on bonus circles for the chance to win a bonus pot before each round.

In an alternate embodiment, every player has the option before each round to bet on the player that has the button in front of her, and if the player on the button wins that round, then they are paid whatever percentage that the casino chooses, and if the button loses, then they lose their bets. The casino chooses how many chips a player must win to win the pot or the game.

According to some embodiments, a casino table game is disclosed with two sets of rules, one for a single table format and another for a tournament format. The rules for the single table format work as follows. One to seven players play on a single casino table, and players can join or leave at any time. Each round, the button moves once clockwise. Each player is required to place the minimum ante bet to play. This bet pays even money. There is also a bonus bet that pays if the player gets three of a kind or better, and the casino determines the payout. To begin the game, the dealer deals out seven hands face up. The player on the button chooses the hand she wants first. The dealer places each chosen hand in the player's box. Then, the player immediately to the left picks the hand they want and so on around the table until everyone has a hand. Then, the dealer mucks the remaining hands not chosen. If there is only one player at the table, then the dealer takes a turn with the player choosing the first hand and mucking it when he or she is the button, then the dealer chooses the second hand when the player is the button and mucks it. This makes it fair for the casino. Once everyone has a hand, the dealer burns one card and turns three cards face up for the flop. A second ante is required to choose a second hand, which is optional, and players can continue with their first hand only. After the flop, the dealer sets out seven more hands face up. Unlike the first choosing of cards, the first player who paid the second ante and is to the left of the button chooses first. Then, the next player to the left chooses and so on until everyone who paid the second ante has two separate hands. The dealer mucks the remaining hands not chosen for the second pick. Then, the dealer proceeds to burn a card and deal the turn card; immediately after the turn, the dealer burns another card and deals the river card. To win the ante bet, the player must get at least a two pair with one hand. Winners get paid even money on both antes; one ante if the player only has one hand. Players with two hands cannot combine their hands. Bonus bets are also paid at this time. The bet is lost if the player didn't make at least three of a kind with either hand. As an example, three of a kind pays two to one, straight pays three to one, flush pays four to one, full-house pays five to one, four of a kind pays six to one, straight flush pays ten to one, and royal flush pays twenty to one. These pay outs will be adjusted accordingly.

The rules for the tournament work as follows. This is based on a multiple table elimination tournament style with a buy-in and a pay out of the top 10% of the field. Eight players are required per table and the casino decides the buy-in and pay-out. Dealers deal one card to each player, and the player with the highest card gets the button. Each round, the button moves clockwise once. To begin the game, the dealer deals out ten hands face up. The player on the button takes the hand he or she wants. Then, the player immediately to the left picks the hand they want and so on around the table until everyone has a hand. Then, the dealer mucks the remaining hands not chosen. Once everyone has a hand, the dealer burns one card and turns three cards face up for the flop. After the flop, the dealer sets out ten more hands face up. Unlike the first choosing of cards, the player immediately to the left of the button chooses first. Then, the next player to the left chooses and so on until everyone has two separate hands. After everyone has two hands, the dealer mucks the remaining hands not chosen. The dealer burns a card and turns the turn and burns another card and turns the river. After the river card, the dealer gives the player with the winning Texas Hold'em hand a casino chip. Players have a chance to win using their two separate hands. In the case of a tie, the dealer deals a card to each player, and the high card wins the chip. When one player on a table wins a certain amount of chips determined by tournament, they move to the next round (this tournament style is called a shootout). Tournament payouts are decided by casino. Players may choose one hand from the seven hands in the middle of the table before the flop and again after the flop if they pay the second ante. Players may place a bet on Bonus circles for the chance to win a Bonus Pot before each round.

### DETAIL DESCRIPTIONS OF THE EMBODIMENTS

A method of playing a card game is provided. The method may include receiving at least one bet from each of a plurality of players. Further, the method may include displaying a plurality of hand cards from a card deck. Further, a count of the plurality of hand cards may be at least equal to a count of the plurality of players. Further, the method may include receiving at least one hand card selection from each of the plurality of players. Further, the at least one hand card selection selects at least one hand card from the plurality of hand cards. Further, the method may include displaying a plurality of flop cards selected from the card deck. Further, the method may include receiving one or more of a second bet, a call, and a fold from each of the plurality of players in response to selection of the plurality of flop cards. Further, the call received from a player matches the initial bet amount previously received from the player. Further, the fold received from a player forfeits the player from winning at least a percentage of the at least one bet, namely the initial bet. Further, the method may include displaying at least one turn card selected from the card deck. Further, the method may include displaying at least one river card selected from the card deck. Further, the method may include forming a plurality of hands corresponding to the plurality of players. Further, a hand corresponding to a player may include the at least one hand card associated with the player and at least one community card selected from a plurality of community cards including the plurality of flop cards, the at least one turn card and the at least one river card. Further, each of the plurality of hands may be associated with a hand rank. Further, a hand rank associated with a hand may be based on one or more of a plurality of card ranks associated with a plurality of cards comprised in the hand and a count of the plurality of cards associated with a card rank. Further, the method may include identifying a winning hand from the plurality of hands. Further, a hand rank associated with the winning hand may be greater than a hand rank associated with every other hand of the plurality of hands. Further, the method may include rewarding the player associated with the winning hand.

In some embodiments, the at least one hand card selection may be received from each of the plurality of players in a sequence. Further, a beginning of the sequence corresponds to each of the plurality of players in a plurality of rounds of the card game respectively.

In some embodiments, the at least one hand card may include two hand cards.

In some embodiments, the count of the plurality of hand cards may be greater than the count of the plurality of players.

In some embodiments, the count of the plurality of hand cards may be equal to twenty.

In some embodiments, the at least one hand card selection may include a first hand card selection and a second hand card selection. Further, the first hand card selection selects at least one first hand card from a first plurality of hand cards. Further, the second hand card selection selects at least one second hand card from a second plurality of hand cards. Further, the first hand card selection may be performed prior to displaying of the plurality of flop cards. Further, the second hand card selection may be performed subsequent to displaying of the plurality of flop cards.

In some embodiments, each of the first hand card selection and the second hand card selection may be received from each of the plurality of players in a first sequence and a second sequence respectively. Further, a beginning of the first sequence associated with the first hand selection corresponds to a first player of the plurality of players. Further, a beginning of the second sequence associated with the second hand selection may be associated with a second player adjacent to the first player.

In some embodiments, the method may further include mucking at least one hand card from the plurality of hand cards. Further, the at least one hand card may not be selected by any of the plurality of players.

In some embodiments, the method may further include burning at least one card prior to displaying of one or more of the plurality of flop cards, the at least one turn card and the at least one river card.

In some embodiments, the winning hand may be characterized by at least three of a kind.

In some embodiments, the winning hand may include at least two pairs of cards. Further, each card of a pair of cards may be associated with an identical card rank. Further, a card rank associated with one or more of the two pairs may be at least equal to ten.

In some embodiments, the winning hand is identified by a predetermined hand rank, wherein the hand rank associated with the winning hand is greater than the predetermined hand rank.

In some embodiments, the winning hand is identified by a hand rank associated with the winning hand being greater than a hand rank associated with every other hand of the plurality of hands.

In some embodiments, the reward may be equal to the initial bet and the call.

In some embodiments, the reward may be equal to a percentage of the bonus bet.

In some embodiments, the reward may be equal to the initial bet, the call, and a percentage of the bonus bet.

In some embodiments, the reward may be equal to the second bet.

A gaming machine for playing a card game may be provided. The gaming machine may include an input device configured for receiving at least one bet from each of a plurality of players. Further, the input device may be configured for receiving at least one hand card selection from each of the plurality of players. Further, the at least one hand card selection selects at least one hand card from the plurality of hand cards. Further, the input device may be configured for receiving one or more of a second bet, a call, and a fold from each of the plurality of players in response to selection of the plurality of flop cards. Further, the call received from a player matches the initial bet amount previously received from the player. Further, the fold received from a player forfeits the player from winning at least a portion of the at least one bet, namely the initial bet. Further, the input device may be configured for forming a plurality of hands corresponding to the plurality of players. Further, a hand corresponding to a player may include the at least one hand card associated with the player and at least one community card selected from a plurality of community cards including a plurality of flop cards, at least one turn card and at least one river card. Further, each of the plurality of hands may be associated with a hand rank. Further, a hand rank associated with a hand may be based on one or more of a plurality of card ranks associated with a plurality of cards comprised in the hand and a count of the plurality of cards associated with a card rank. Further, the gaming machine may include an output device configured for displaying a plurality of hand cards from a card deck. Further, a count of the plurality of hand cards may be at least equal to a count of the plurality of players. Further, the output device may be configured for displaying the plurality of flop cards selected from the card deck. Further, the output device may be configured for displaying the at least one turn card selected from the card deck. Further, the output device may be configured for displaying the at least one river card selected from the card deck. Further, the gaming machine may include a processing device configured for identifying a winning hand from the plurality of hands. Further, a hand rank associated with the winning hand may be greater than a hand rank associated with every other hand of the plurality of hands. Further, the processing device may be configured for rewarding the player associated with the winning hand.

In some embodiments, the at least one hand card selection may be received from each of the plurality of players in a sequence. Further, a beginning of the sequence corresponds to each of the plurality of players in a plurality of rounds of the card game respectively.

In some embodiments, the at least one hand card may include two hand cards.

In some embodiments, the count of the plurality of hand cards may be greater than the count of the plurality of players.

In some embodiments, the count of the plurality of hand cards may be equal to twenty.

In some embodiments, the at least one hand card selection may include a first hand card selection and a second hand card selection. Further, the first hand card selection selects at least one first hand card from a first plurality of hand cards. Further, the second hand card selection selects at least one second hand card from a second plurality of hand cards. Further, the first hand card selection may be performed prior to displaying of the plurality of flop cards. Further, the second hand card selection may be performed subsequent to displaying of the plurality of flop cards.

In some embodiments, each of the first hand card selection and the second hand card selection may be received from each of the plurality of players in a first sequence and a second sequence respectively. Further, a beginning of the first sequence associated with the first hand selection corresponds to a first player of the plurality of players. Further, a beginning of the second sequence associated with the second hand selection may be associated with a second player adjacent to the first player.

In some embodiments, the processing device may be further configured for mucking at least one hand card from the plurality of hand cards. Further, the at least one hand card may not be selected by any of the plurality of players.

In some embodiments, the processing device may be further configured for burning at least one card prior to displaying of one or more of the plurality of flop cards, the at least one turn card and the at least one river card.

In some embodiments, the winning hand may be characterized by at least three of a kind.

In some embodiments, the winning hand may include at least two pairs of cards. Further, each card of a pair of cards may be associated with an identical card rank. Further, a card rank associated with one or more of the two pairs may be at least equal to ten.

In some embodiments, the winning hand is identified by a predetermined hand rank, wherein the hand rank associated with the winning hand is greater than the predetermined hand rank.

In some embodiments, the winning hand is identified by a hand rank associated with the winning hand being greater than a hand rank associated with every other hand of the plurality of hands.

In some embodiments, the reward may be equal to the initial bet and the call.

In some embodiments, the reward may be equal to a percentage of the bonus bet.

In some embodiments, the reward may be equal to the initial bet, the call, and a percentage of the bonus bet.

In some embodiments, the reward may be equal to the second bet.

Although the invention has been explained in relation to its preferred embodiment, it is to be understood that many other possible modifications and variations can be made without departing from the spirit and scope of the invention.

I claim:

1. A method of playing a card game, the method comprising:
receiving at least one bet from each of a plurality of players;
displaying a plurality of hand cards from a card deck, wherein a count of the plurality of hand cards is at least equal to a count of the plurality of players;
receiving at least one hand card selection from each of the plurality of players, wherein the at least one hand card selection selects at least one hand card from the plurality of hand cards;
displaying a plurality of flop cards selected from the card deck;
receiving at least one of a second bet, a call, or a fold from each of the plurality of players in response to selection of the plurality of flop cards, wherein the second bet wherein the call received from a player matches an initial bet from the at least one bet previously received from the player, wherein the fold received from a player forfeits at least a portion of the bet received from the player;
displaying at least one turn card selected from the card deck;
displaying at least one river card selected from the card deck;
forming a plurality of hands corresponding to the plurality of players, wherein a hand corresponding to a player comprises the at least one hand card associated with the player and at least one community card selected from a plurality of community cards comprising the plurality of flop cards, the at least one turn card, and the at least one river card, wherein each of the plurality of hands is associated with a hand rank, wherein the hand rank associated with a hand is based on at least one of a plurality of card ranks associated with a plurality of cards comprised in the hand and a count of the plurality of cards associated with a card rank;
identifying a winning hand from the plurality of hands; and
rewarding the player associated with the winning hand.

2. The method of claim 1, wherein the at least one hand card selection is received from each of the plurality of players in a sequence, wherein a beginning of the sequence corresponds to each of the plurality of players in a plurality of rounds of the card game respectively.

3. The method of claim 1, wherein the at least one hand card comprises two hand cards.

4. The method of claim 1, wherein the count of the plurality of hand cards is greater than the count of the plurality of players.

5. The method of claim 1, wherein the count of the plurality of hand cards is equal to twenty.

6. The method of claim 1, wherein the at least one hand card selection comprises a first hand card selection and a second hand card selection, wherein the first hand card selection selects at least one first hand card from a first plurality of hand cards, wherein the second hand card selection selects at least one second hand card from a second plurality of hand cards, wherein the first hand card selection is performed prior to displaying of the plurality of flop cards, wherein the second hand card selection is performed subsequent to displaying of the plurality of flop cards and receiving of the second bet.

7. The method of claim 6, wherein each of the first hand card selection and the second hand card selection is received from each of the plurality of players in a first sequence and a second sequence respectively, wherein a beginning of the first sequence associated with the first hand selection corresponds to a first player of the plurality of players, wherein a beginning of the second sequence associated with the second hand selection is associated with a second player adjacent to the first player.

8. The method of claim 6, wherein the reward is equal to the second bet received from the player.

9. The method of claim 1 further comprising mucking at least one hand card from the plurality of hand cards, wherein the at least one hand card is not selected by any of the plurality of players.

10. The method of claim 1 further comprising burning at least one card prior to displaying of at least one of the plurality of flop cards, the at least one turn card, and the at least one river card.

11. The method of claim 1, wherein the winning hand is characterized by at least three of a kind.

12. The method of claim 1, wherein the reward is equal to the initial bet and the call received from the player.

13. The method of claim 1, wherein the at least one bet comprises a bonus bet, wherein the reward is equal to a percentage of the bonus bet.

14. The method of claim 1, wherein the at least one bet comprises a bonus bet, wherein the reward is equal to the initial bet, the call, and a percentage of the bonus bet.

15. The method of claim 1, wherein a hand rank associated with the winning hand is greater than a hand rank associated with every other hand of the plurality of hands.

16. The method of claim 1, wherein the hand rank associated with the winning hand is greater than or equal to a predetermined hand rank.
